(19) United States
(12) Patent Application Publication
(10) Pub. No.: US 2003/0093983 A1
(43) Pub. Date: May 22, 2003

(54) Maneuverable and adjustable lawn mower having an edger-trimming unit

(76) Inventors: Serge Savard, St-Colomban (CA); Sylvain Boudreau, St-Jerome (CA); Richard Gagnon, Montreal (CA)

Correspondence Address: Sylvain Boudreau, Suite 1607, 4050 Rosemont Blvd, Montreal, QC, H1X 1M4, CA

(21) Appl. No.: 09/988,475

(22) Filed: Nov. 20, 2001

(51) Int. Cl. A01D 43/16

(52) U.S. Cl. 56/12.7

(57) ABSTRACT

A lawn mower having an engine shaft for rotatably driving a set of cutting blades, and also adapted to selectively drive a built-in. The edging unit being selectively engaged to said engine shaft by a clutch type mechanism. A means for adjusting the relative height between a front caster-type wheel and the lawn mower frame. A handle extending from the lawn mower frame that is pivotally attached to allow pivotal rotation relative to the frame about two substantially perpendicular rotational axis and a selective locking means for releasably locking the handle in a predetermined position.

### FIELD OF THE INVENTION

The present invention relates to the general field of lawn mowers and is particularly concerned with a maneuverable and adjustable lawn mower having an edging unit.

### BACKGROUND OF THE INVENTION

Lawn maintenance typically involves cutting of grass at regular time intervals. The most widely used implement for performing such function is the conventional gasoline or electric engine powered rotary lawn mower.

Although the lawn mower is particularly well suited for cutting relatively large areas of grass, it is often unable to adequately cut grass particularly around plantings, flowers, edges, raised obstructions and the like.

Separate machines are sold for accomplishing such edging and trimming purposes, and they usually include a cutting head having a cutting flail extending therefrom. The cutting head is typically supported on the end of the long handle that can be oriented horizontally for trimming or vertically for edging during use.

Thus, once the lawn is cut with the lawn mower, it is necessary to obtain and use another tool for the final trimming of the lawn. This entails additional costs and requires additional maintenance for the purchasing and care of a separate implement. Furthermore, the use of two separate pieces of equipment increases the overall time required for performing a given task.

Accordingly, the prior art has shown some attempts at designing a combined lawn mower and trimmer thereby allowing the intended operator to trim the lawn without the necessity of obtaining a separate tool located remotely from the lawn mower. However, the prior art attempts have provided generally complex structures requiring substantial or otherwise undesirable modification to the mower in order to receive the attachment. The prior art attempts have produced structures having undesirable features which the present disclosure seeks to improve.

Another common problem related to conventional grass lawn mowers relates to their lack of maneuverability at least in part related to the configuration of the supporting wheels. This lack of maneuverability provides for an unergonomical handling of the lawn mower leading to frustration and potential injuries to the intended user.

Still further, another common drawback associated with conventional lawn mowers relates to the type of connection between the lawn handle and the lawn mower frame which also deters the overall ergonomic aspects of the lawn mower.

Accordingly, there exists a need for an improved maneuverable and adjustable lawn mower having an edging unit.

Advantages of the present invention include that the proposed lawn mower has a built-in edging unit that can be either directly built onto new models or retro-fitted to conventional models without requiring substantial modifications thereto. The edging unit is of a simple construction so as to provide a unit that will be economically feasible, long lasting and relatively trouble free in operation.

Furthermore, the proposed lawn mower is provided with a three wheel support configuration using a caster-type wheel having a specifically designed height adjustment mechanism. The height adjustment mechanism of the caster-type wheel allows for ergonomical and easy customization of the relative position between the supporting wheel and the lawn mower frame.

Still further, the proposed lawn mower is provided with a lawn mower handle being pivotable about two distinct and substantially orthogonal rotational axis. The lawn mower handle pivotal axis is provided with a releasable locking mechanism for allowing releasable locking thereof in a set of predetermined relative positions relative to the lawn mower frame.

### BRIEF DESCRIPTION OF THE DRAWINGS

An embodiment of the present invention will now be disclosed, by way of example, in reference to the following drawings in which:

FIG. 1: In a perspective view, illustrates a maneuverable and adjustable lawn mower having an edging unit in accordance with an embodiment of the present invention.

FIG. 2: In a partial top view with sections taken out, illustrates part of the body of the lawn mower shown in FIG. 1.

FIG. 3: In a partial side elevational view with sections taken out, illustrates part of the lawn mower shown in FIG. 1 with its handle in a storage configuration.

FIG. 4: In a schematic partial top view with sections taken out, illustrates part of the handle unit of the lawn mower shown in FIG. 1 with its handle in an operational configuration.

FIG. 5: In a schematic partial top view with sections taken out, illustrates part of the handle unit of the lawn mower shown in FIG. 1 with its handle in plier pivoted configurations, some of which being shown in phantom lines.

FIG. 6: In a partial elevational view with sections taken out, illustrates part of the height adjustment mechanism of the lawn mower shown in FIG. 1.

FIG. 7: In a partial elevational view with sections taken out, illustrates the mechanism shown in FIG. 6 with its locking component being lifted away from the locking base.

FIG. 8: In a partial elevational view with sections taken out, illustrates the components shown in FIGS. 6 and 7 with the locking component being pivoted relative to the locking base and the adjustment knob being rotated so as to decrease the height of the front section of the lawn mower.

FIG. 9: In a partial elevational view with sections taken out, illustrates the component shown in FIGS. 6 through 8 with the locking component being biased back towards the locking base and the adjustment knob rotated so as to increase the height of the front section of the lawn mower.

FIG. 10: In a partial detailed view with sections taken out, illustrates part of the drive mechanism used for driving the edging unit, the drive mechanism being shown in an non operational configuration.

FIG. 11: In a partial detailed view with sections taken out, illustrates part of the drive mechanism used for driving the edging unit, the drive mechanism being shown in an operational configuration.

FIG. 12: In a partial side view with sections taken out, illustrates part of the locking mechanism for locking the lawn mower handle in a predetermined position. The locking mechanism being shown in the storage position.

FIG. 13: In a partial side view with sections taken out, illustrates part of the locking mechanism for locking the lawn mower handle in a predetermined position. The locking mechanism being shown in the operational configuration.

FIG. 14: In a partial top view with sections taken out, illustrates the locking mechanism shown in FIGS. 12 and 13.

### DETAILED DESCRIPTION OF THE DRAWINGS

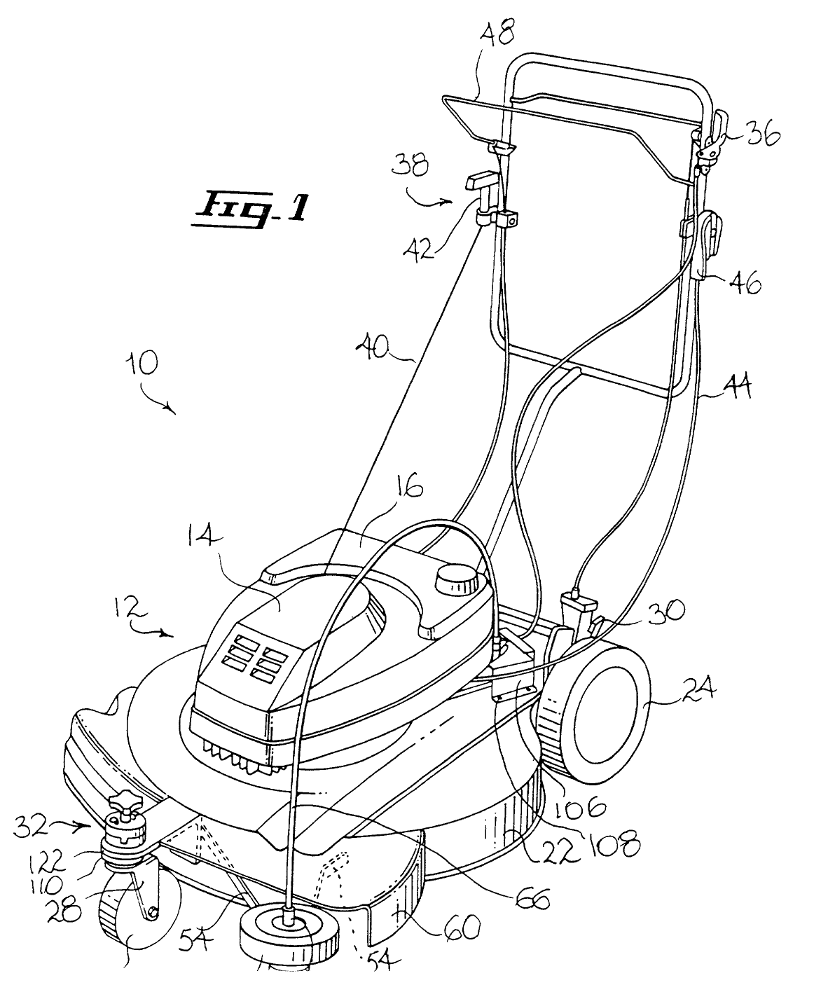

Referring to FIG. 1, there is shown a maneuverable and adjustable three wheeled lawn mower 10 in accordance with an embodiment of the present invention. The lawn mower 10 is typically of the walk-behind type and is provided with a frame 12 supporting a rotary engine 14. The rotary engine 14 is shown as being of a fuel driven type including a fuel compartment 16 but could be of the electrical or other power source type without departing from the scope of the present invention.

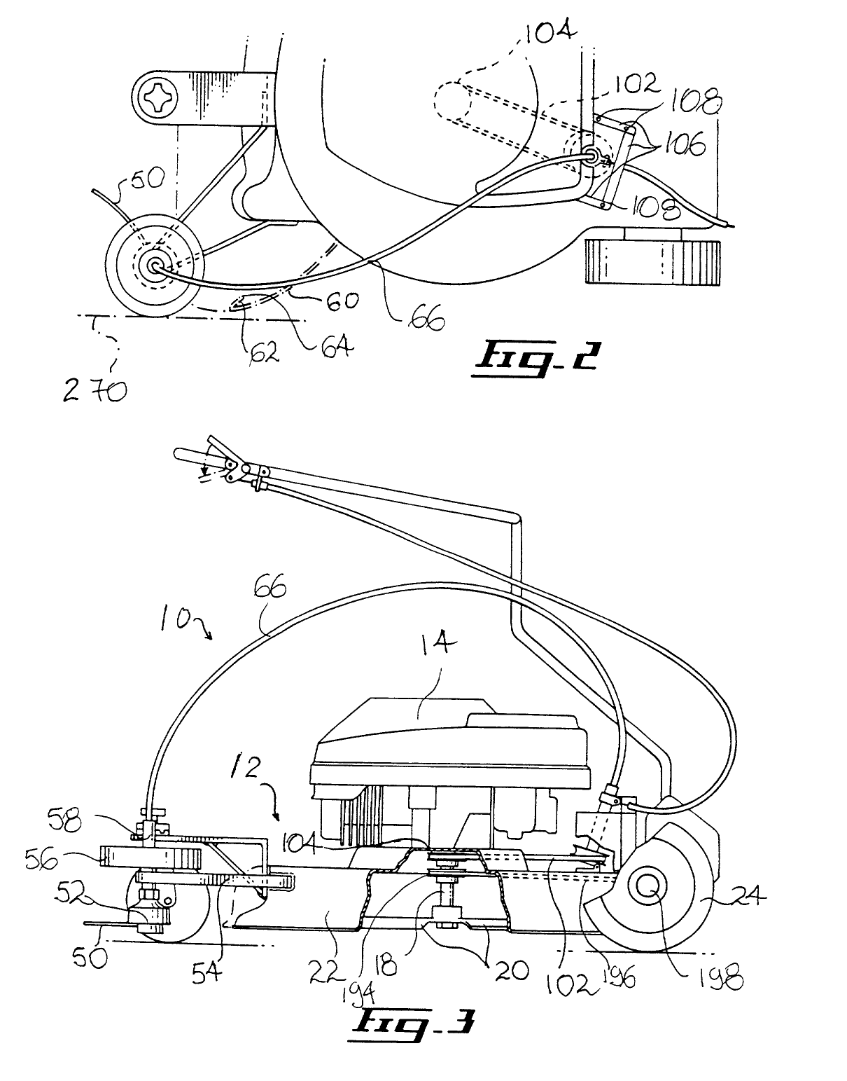

As shown in FIG. 3, the engine 14 is mounted on the deck of the frame 12 and drives a main engine shaft 18 to which a set of main mower blades 20 are attached. The frame 12 includes a downwardly extending skirt 22 for protectively partially enclosing the blades 20 as is well known in the art.

The lawn mower 10 is preferably of the three wheeled type including a pair of rear wheels 24 rotatably attached to a rear section of the frame 12 and a front caster-type wheel 26 rotatably attached to a caster-type wheel attachment bracket 28.

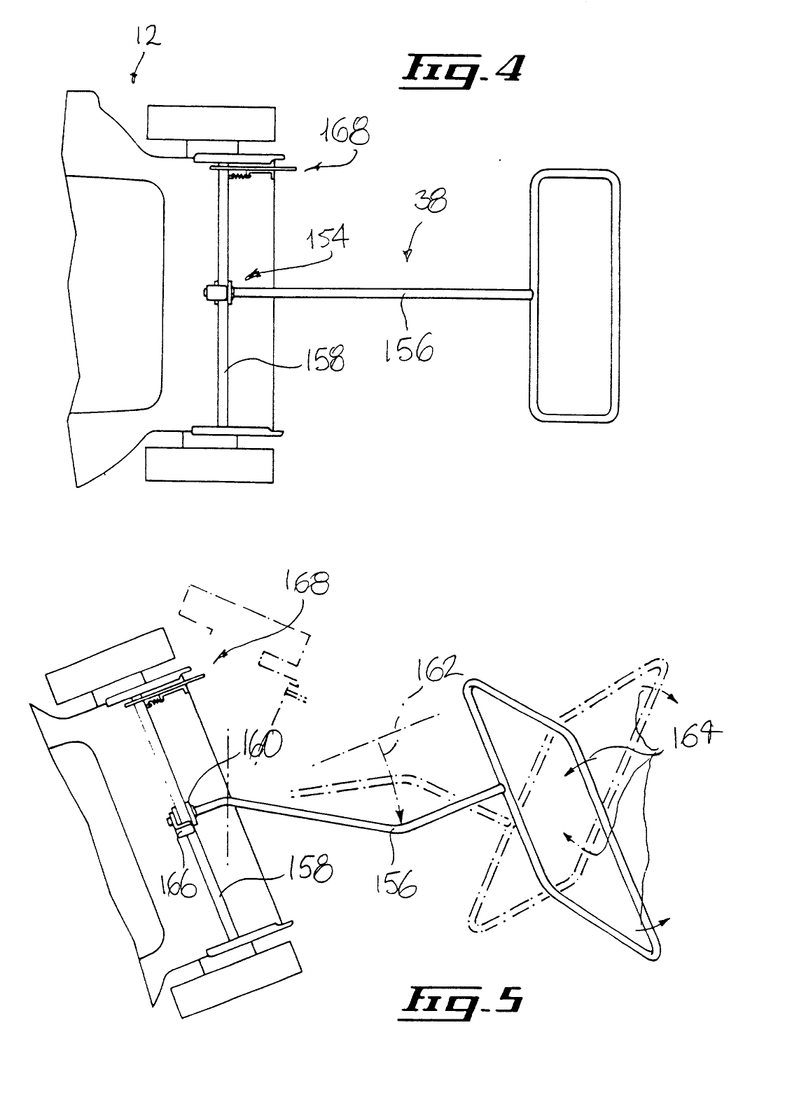

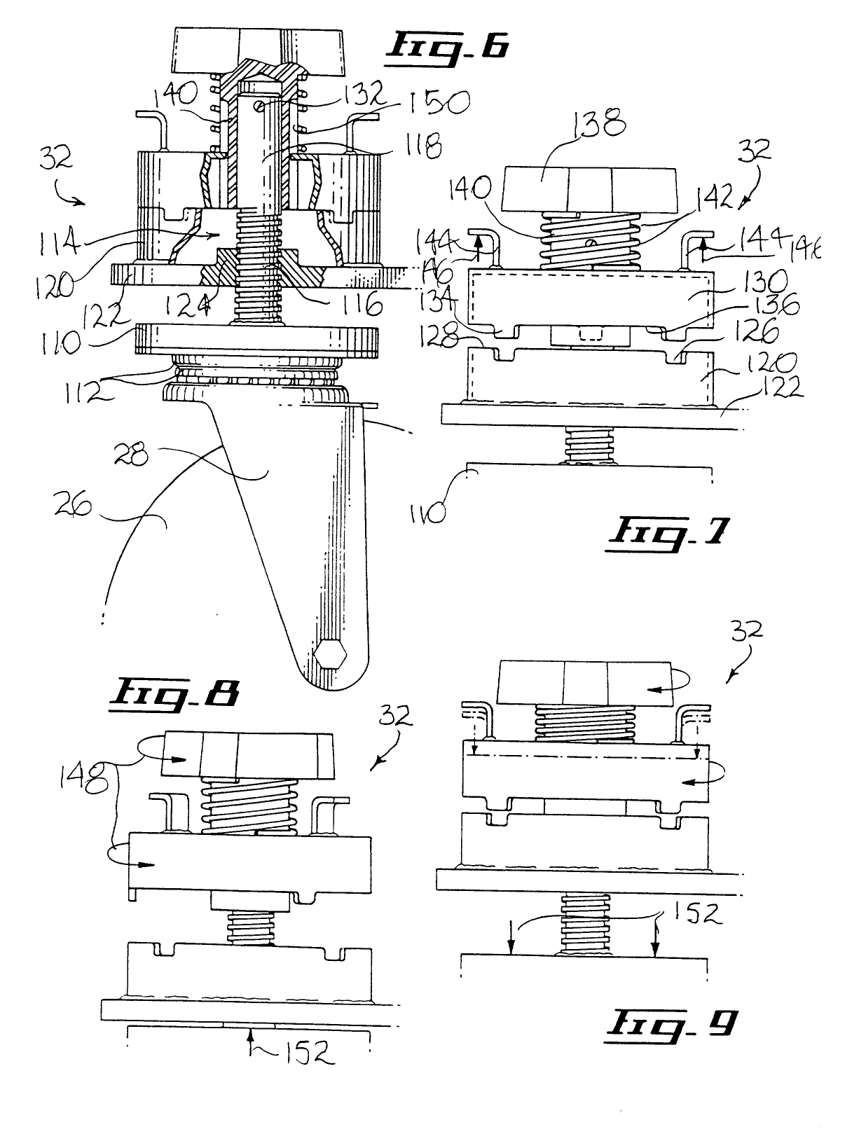

A conventional mechanism including a lever 30 for adjusting the relative height between the frame 12 and the rear wheels 24 is also provided. The relative height between the frame 12 and the caster-type front wheel 26 is preferably adjusted using a front wheel-to-frame height adjustment mechanism 32, illustrated in greater details in FIGS. 6 through 9.

The lawn mower 10 is typically further provided with a rear wheel driving assembly including a rear wheel driving pulley 194 attached to the engine shaft 18 and a rear wheel driving belt 196 mechanically coupling the rear wheel driving pulley 194 and a driving structure attached to the rear wheel axles 198.

One of the main features of the present invention resides in the presence of an edging unit 34 attached to the frame 12 and provided with an actuating lever 36 for selectively actuating the driving components of the edging unit 34. The lawn mower 10 is further provided with a lawn mower handle component 38.

Another main feature of the present invention resides in the pivotal connection between the handle component 38 and the frame 12, allowing for relative movement therebetween, as shown in FIGS. 4 and 5 that will be hereinafter disclosed in greater details.

The engine 14 is typically provided with conventional external components such as a starter rope 40, having a conventional starter handle 42 and a throttle cable 44, having a conventional throttle lever 46. Other relative standard components such as a circuit breaker pivotal rod 48 and the like is also further provided. It should be understood that various other items could be added and that modifications to the herein above disclosed items could be made without departing from the scope of the present invention.

The edging unit 34 includes: a conventional flail member filament 50, attached in a conventional manner to a driven flail head 52. The flail head 52 is solidly attached to the frame 12 using a flail head mounting bracket typically including a pair of flail head mounting legs 54. Alternatively, the flail head 52 could be pivotally attached to the frame 12 so as to allow the flail head 52 to pivot so that the flail member filament 50 may be rotated between a vertical and a horizontal cutting plane.

Another main feature of the present invention resides in the presence of a guiding wheel 56, rotatably mounted on a guiding wheel shaft 58 also attached to the flail mounting legs 54. The guiding wheel 56 has a peripheral surface adapted to rollably abut against guiding surfaces such as edge walls, fences or the like 270. Alternatively, the guiding wheel 56 could be provided with size adjustment wheels or may be provided with relative positioning means so as to allow customization of the relative position thereof relative to the frame 12 so as to customize its abutment function to different types of environments.

The skirt 22 is provided with a skirt edging unit section 60 extending integrally therefrom. The skirt edging unit section 60 is configured, sized and positioned so as to at least partially enclose the mounting legs 54 while allowing at least a section of the guiding wheel 56 and of the flail member 50 to protrude therefrom. The skirt edging unit section 60 typically protrudes sidewardly and frontwardly from the conventional peripheral edge of the skirt 22 protectively enclosing the cutting blades 20. As shown in greater details in FIG. 2, the skirt edging unit section 60 is provided with an inwardly bent cutting segment 62 defining a sharp cutting edge 64. The sharp cutting edge 64 is positioned so as to contact the distal end of the flail member 50 when the latter reaches a predetermined length so as to inherently maintain the flail member 50 at a predetermined customized length.

The flail member head 52 is mechanically coupled to the conventional driving cable 68 rotatably inserted within a conventional driving cable sleeve 66. The driving cable 68 and associated driving cable sleeve 66 typically form an arch from the flail member head 52 towards a rearward section of the lawn mower 10.

As illustrated more specifically in FIGS. 10 and 11, the driving cable 68 is mechanically coupled to an edging unit driving shaft 70 extending from an edging unit driven pulley 72. The edging unit driven pulley 72 is pivotally attached to a base segment 74 of the skirt 22 using a driven pulley attachment unit 76.

The driven pulley attachment unit 76 includes a first attachment bracket 78 attached to the base wall 74 and a second attachment bracket 80 pivotally attached to the first attachment bracket 78 by a hinge component 82 and also attached to a mounting hub 84 around which the driven pulley 72 rotates. The first attachment bracket 78 is preferably attached to the base wall 74 using conventional fastening means such as bolt 86 and nut 88 arrangements extending through a position adjustment slot 90 formed in the base wall 74 and allowing relative position adjustment between the first attachment bracket 78 and the base wall 74.

The shaft 70, the hub 84 and the associated driven pulley 72 are adapted to be pivoted relative to the base wall 74 about the pivotal axis created by the hinge component 82 as indicated by arrow 100 in FIG. 11. A clutch cable 94 extending through a clutch cable sleeve 96 is attached to the shaft 70 using an attachment collar 98. The clutch cable 94 is adapted to be pulled as indicated by arrow 100 by the pivotal movement of the clutch lever 36.

An edging unit driving belt 102 is wound around the driven pulley 72. As shown more specifically in FIGS. 2 and 3, the edging unit driving belt 102 is also wound about an edging unit driving pulley 104, mechanically coupled to the engine driving shaft 18.

When the driven pulley 72 is in the inoperative position shown in FIG. 10, the edging unit driving belt 102 rotates freely therearound without causing rotation of the driving shaft 70 and associated driving cable 78. When the actuating lever 36 is pivoted so that the clutch cable 94 pulls the driven pulley 72 in the operative position, shown in FIG. 11, the edging unit driving belt 102 becomes taught so that rotation of the edging unit driving pulley 104 is mechanically transmitted to the driven pulley 72 and to the driving cable 68. In turn, the driving cable 68 causes rotation of the flail member head 52 and the corresponding flail member 50 attached thereto. Optionally, a biasing means could be used to ensure the pivotal movement of the driven pulley 72 towards the inoperative position shown in FIG. 10 when the clutch lever 36 is pivoted back to its original position.

Preferably, a set of guarding walls 106 extend from the base wall 74 adjacent the driven pulley 72 so as to form a partial enclosure for preventing potential contact with the rotating components. The protective walls 106 are preferably releasably mounted to the base wall 74 by conventional fastening means such as bolts 108 so as to allow access to the protected components for maintenance, repairs or the like.

Referring now more specifically to FIGS. 6 through 9, there is shown in greater details the height adjustment means for adjusting the relative height between the caster-type wheel 26 and the frame 12. The caster-type wheel mounting bracket 28 is pivotally attached to a caster wheel base plate 110 by a set of conventional roller bearing type components 112. A caster-type wheel mounting bracket 122 preferably having a generally “L” shaped configuration is attached to the frame 12 with its shorter leg attached to the frame 12 and its longer leg extending frontwardly therefrom.

An adjustment stem 114 extends upwardly from the base plate 110. The adjustment stem 114, defines a stem threaded segment 116 positioned proximal to the base plate 110 and a stem attachment segment 118 positioned distally relative to the base plate 110.

A first locking disc 120 is threatably mounted on the stem threaded segment 116 by an internal threaded collar 124. The first locking disc 120 is provided with a set of locking recesses 126 formed on its upper peripheral edge 128. A second locking disc 130 is solidly attached to the stem attachment segment 118 by an attachment screw 132 or any other suitable means. The second locking disc 130 is provided with a set of protruding teeth 134 extending integrally from its lower peripheral edge 136. The teeth 134 are configured, sized and positioned so as to be insertable within the locking recesses 126 of the first locking disc 120 so as to selectively prevent relative rotation therebetween.

The second locking disc 130 is slidably mounted on a knob spacing segment 140 extending integrally from a knob component 138. A biasing means for biasing the second locking disc 130 away from the knob component 138 is further provided. The biasing means preferably takes the form of a helicoidal-type spring 142 compressively positioned between the lower face of the knob component 138 and the upper face of the second locking disc 130.

In order to adjust the relative height between the caster-type wheel 26 and the frame 12, the intended user merely needs to use his/her finger to grasp the grasping legs 144 and lift the second locking disc 130 away from the first locking disc 120 as indicated by arrows 146. The second locking disc 130 is lifted away from the first locking disc 120 until the locking teeth 134 disengage the locking recesses 126 as shown in FIG. 7.

As shown in FIG. 8, the knob 138 is then rotated according to arrow 148 causing simultaneous rotational movement of the second locking disc 130 attached thereto through the locking screw 132.

The longitudinal channel 150 formed in the spacing segment 140 allows for vertical displacement of the second locking disc 130 as the threaded segment 116 causes relative vertical displacement between caster-type wheel mounting bracket 122 and the base plate 110 in both vertical directions as shown by arrows 152. When the desired relative height is reached between the caster-type wheel 26 and the frame 12, the grasping legs 144 are released and the locking teeth 134 inserted within corresponding locking recesses 126 to prevent relative rotational displacement between the first 120 and second 130 locking discs.

Another main feature of the present invention resides in the configuration of the pivotal connection 154 between the handle 38 and the lawn mower frame 12. The pivotal connection 154, as shown in FIGS. 4 and 5, allows the handle stem 156 to pivot simultaneously in two different geometrical planes relative to the handle pivot axis 158. A handle pivot sleeve 160 allows pivotal movement of the handle stem 156 according to arrow 162 in a geometrical plane substantially perpendicular to the axis 158 while also allowing pivotal movement of the handle stem 156 in a generally perpendicular geometrical plane as indicated by arrows 164. The pivotal movement in the perpendicular axis indicated by arrows 164 is at least partially restricted by a stopper bracket 166 extending from the pivotal sleeve 160 and having an abutment leg thereof adapted to abut against the pivotal axis 158 as shown in FIG. 5.

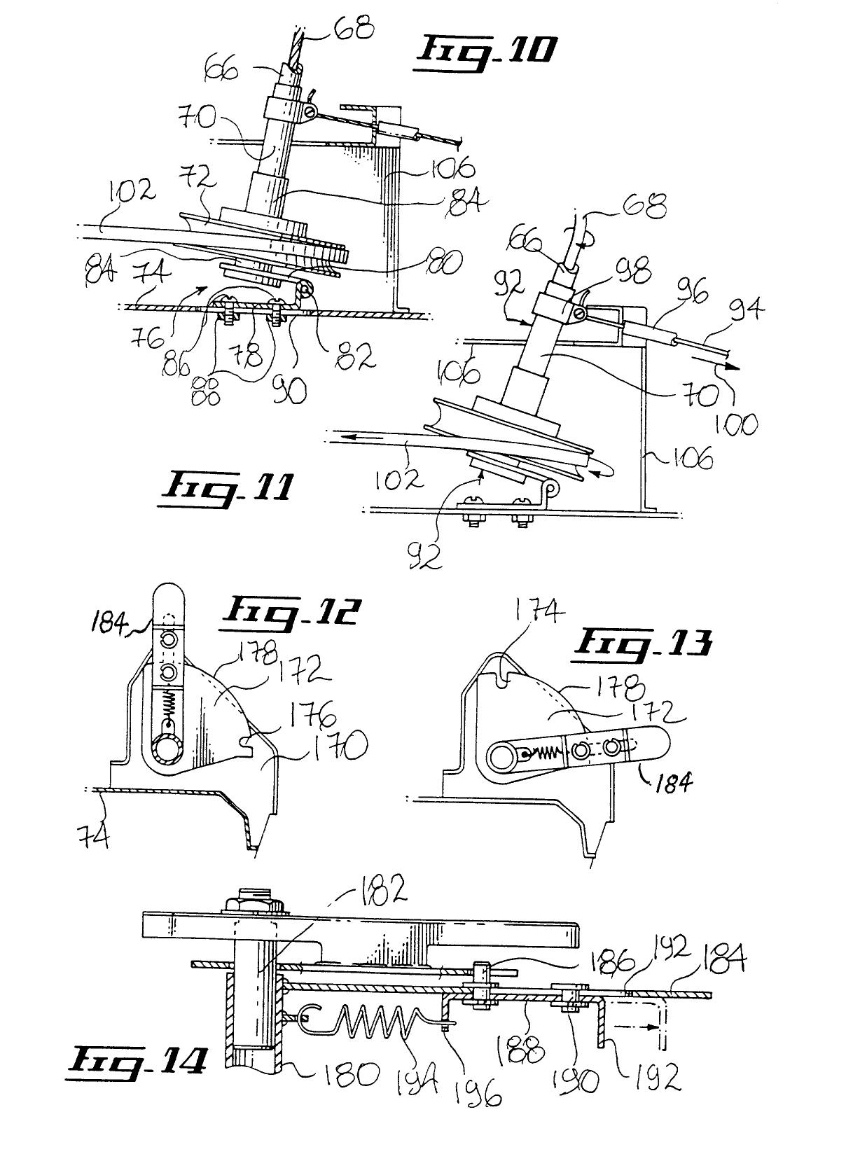

Yet another main feature of the present invention resides in a locking means for releasably locking the handle 38 in a predetermined storage configuration. The locking means 168 shown schematically in FIGS. 4 and 5 is illustrated in greater details in FIGS. 12 through 14. A rear wheel adjustment brace 170 extends from the base wall 74 in a conventional manner. A locking plate 172 is solidly attached to the brace 170 using weld-lines or any other suitable means. The locking plate 172 is provided with a pair of locking notches 174, 176 formed on its preferably arcuate peripheral edge 178.

The handle pivotal axis 158 includes a pivotal rod 180 rotatably mounted about a pair of rod pivotal mounting pins 182—only one of which is shown in FIG. 14—extending through both the brace 170 and the locking bracket 172. The pivotal rod 180 is adapted to rotate freely about the mounting pins 182 attached to the brace 170.

A locking handle 184 extends radially from the outer surface of the pivotal rod 180. The locking handle 184 is provided with a locking pin 186 slidably mounted thereonto. The locking pin 186 is preferably mounted on a locking pin mounting bracket 188 having a guiding pin 190 slidiingly guided through a guiding slot 192 formed in the locking handle 184.

A biasing means for biasing the locking pin towards its retracted position shown in FIG. 14 is further provided. The biasing means preferably takes the form of a helicoidal-type spring 194 attached at a first end thereof to the pivotal rod 180 and at a second longitudinal edge thereof to a spring attachment leg 196 extending from the mounting bracket 188. The mounting bracket 188 further defines a grasping peg 192 for allowing the fingers of an intended user to slide the mounting bracket 188 and associated locking pin 186 within the guiding slot 192.

The locking pin 186 is adapted to be releasably inserted within the locking notches 174, 176 for selectively locking the handle stem 156 in either its storage position shown in FIGS. 3 and 12 or in its operational configuration shown in FIGS. 1, 4, 5, and 13. The helicoidal-type spring 194 is adapted to prevent unwanted release of the locking pin 186 form the locking notches 174, 176 as is well known in the art.

1. A maneuverable and adjustable lawn mower comprised of:
a conventional lawn mower engine mounted on a conventional lawn mower frame, said lawn mower engine having an engine shaft for rotatably driving a set of cutting blades, said engine shafts being also adapted to selectively drive and edging unit, said edging unit being selectively engaged to said engine shaft by a clutch type mechanism, a means for adjusting the relative height between a front caster-type wheel and said lawn mower frame, a handle extending from said lawn mower frame, said handle being pivotally attached to said frame so as to allow pivotal rotation relative to said frame about two substantially perpendicular rotational axis and a selective locking means for releasably locking said handle in predetermined relative position relative to said lawn mower frame.

2. A maneuverable and adjustable lawn mower as described in claim 1 is comprised of:
an edging unit having a flail head that is pivotally attached to the frame so as to allow the said flail head to pivot so that the flail member filament may be rotated between a vertical and a horizontal cutting plane.

3. A maneuverable and adjustable lawn mower as described in claim 1 is comprised of:
an edging unit having a guiding wheel that has a peripheral surface adapted to rollably abut against guiding surfaces such as edge walls, fences or the like.

4. A maneuverable and adjustable lawn mower as described in claim 3 is comprised of:
a guiding wheel with relative positioning means so as to allow customization of the relative position thereof relative to the frame so as to customize its abutment function to different types of environments.

5. A maneuverable and adjustable lawn mower as described in claim 3 is comprised of:
an edging unit comprised of a driving cable mechanically coupled to the said edging unit driving shaft extending from an edging unit driven pulley and the edging unit driven pulley is pivotally attached to a base segment of a skirt using a driven pulley attachment unit.

6. A maneuverable and adjustable lawn mower as described in claim 3 is comprised of:
an edging unit driving belt wound around the driven pulley and also wound about an edging unit driving pulley and said edging unit driving pulley mechanically coupled to the engine driving shaft.

7. A maneuverable and adjustable lawn mower as described in claim 3 is comprised of:
an actuating lever which is pivoted so that a clutch cable pulls the driven pulley in the operative position wherein the edging unit driving belt becomes taught so that rotation of the edging unit driving pulley is mechanically transmitted to the driven pulley and to a driving cable.

8. A maneuverable and adjustable lawn mower as described in claim 1 is comprised of:
A height adjustment means wherein the relative height between a caster-type wheel and the frame is adjusted with the use of one or more fingers to grasp grasping legs and lift a second locking disc away from a first locking disc and when the second locking disc is lifted away from the first locking disc, locking teeth disengage locking recesses.

9. A maneuverable and adjustable lawn mower as described in claim 1 is comprised of:
a handle bar capable of pivoting simultaneously in two different geometrical planes relative to a handle pivot axis which allows pivotal movement of the handle in a geometrical plane substantially perpendicular to one axis while also allowing pivotal movement of the said handle in a generally perpendicular geometrical plane.

10. A maneuverable and adjustable lawn mower as described in claim 1 is comprised of:
a helicoidal-type spring attached at a first end thereof to a pivotal rod and at a second longitudinal edge thereof to a spring attachment leg extending from a bracket and a mounting bracket further defining a grasping peg for allowing the fingers of an intended user to slide the bracket and associated locking pin within a guiding slot and the locking pin is adapted to be releasably inserted within locking notches for selectively locking the handle stem in either its storage position or in its operational configuration.
